(19) United States
(12) Patent Application Publication
(10) Pub. No.: US 2009/0307072 A1
(43) Pub. Date: Dec. 10, 2009

(54) Apparatus and Method for Managing Bank Account Services, Advertisement Delivery and Reward Points

(76) Inventor: Manuel Antonio Morales-Lema, San Juan, PR (US)

Correspondence Address: EUGENIO J. TORRES, 221 PLAZA BUILDING, PONCE DE LEON, SUITE 403, SAN JUAN, PR, 00917, US

(21) Appl. No.: 12/471,613

(22) Filed: May 26, 2009

Related U.S. Application Data
(60) Provisional application No. 61/059,422, filed on Jun. 6, 2008.

(51) Int. Cl. G06Q 40/00; G06Q 30/00

(52) U.S. Cl. 705/14.17; 705/14.23

(57) ABSTRACT

A system to securely and effectively control, process and manage financial services, targeted advertisement delivery, multiple account cards and reward points comprising a web portal or financial institution internet banking portal, offering financial services comprising a secure and effective on-line apparatus and method to manage bank account services, reward points, account cards and advertisement by matching users with advertisers wherein accurate information, such as current personally identifiable financial and transactional information as well as on-line behavioral data, is employed by means to securely process, control and manage financial information located within the premises of the financial institution providing the financial services as one of the criteria for matching advertisers with users.

### RELATED APPLICATIONS

This application is related to Provisional U.S. patent application Ser. No. 61/059422 filed on Jul. 6, 2008

### STATEMENT REGARDING FEDERALLY SPONSORED RESEARCH AND DEVELOPMENT

N/A

### BACKGROUND OF THE INVENTION

1. Field of the Invention

The invention is related to means for managing bank account services, advertisement delivery and reward points, and more particularly to an apparatus and method for managing financial information for advertisement purposes, reward points and funds transactions.

2. Discussion of the Background

Web portals often function as a point of access to information on the World Wide Web and provide several services such as a search engine, e-mail, news, stock prices, information, entertainment and several other free services making them attractive to users. Portals present information from different sources and provide a mass communication medium for advertisers.

Web portals seek advertisers to generate income by selling advertising space (“ads”) to advertisers who want to place advertisements through the web portal's advertising network (“Ad Network”).

Due to its intermediary nature, a web portal monetizes its services by providing the ability to match a consumer with a given advertiser's ad. Usually the web portal's Ad Networks charge advertisers different fees for placing ads based on the web portal's ability to target specific audiences. Unfortunately, web portals are not very effective at matching consumers with advertisements. Current industry click-thru-rates are approximately 0.1% which translates into 99.9% of advertising waste (“Adwaste”). The same way a driver may pass a billboard on the road and never be aware of it, a web portal's users may never notice ad banners as they surf the different portions of the web portal. The more effective a web portal is at pairing a consumer with an ad, the more it can charge an advertiser for this service. This kind of matching is known in the industry as targeted advertising.

All of the major web portals have recently acquired companies that have developed consumer targeting technologies. These technologies are known as behavioral targeting. Behavioral targeting uses information collected from an individual's web-browsing behavior, such as the pages they have visited—known as click stream data—the searches they've made, the ads they've clicked and the ads they have not clicked in order to select which advertisements to display to a given individual. Although advanced, these technologies are not reliable, nor accurate, means to gather information about a consumer, given that these technologies rely on information gathered from users solely while they are online.

Institutions such as banks, credit unions, check businesses and other similar institutions most of the time possess information such as financial information. The financial information is considered accurate information which advertisers want to benefit from or capitalize upon for their value in the marketing world. Said information includes data, such as personal information, purchasing habits, including preference of stores, actual transaction data and how often the user visits a given store, among others. However, even if this information could be provided to the advertiser under applicable federal and state banking regulations it may still be difficult to get the attention of the web portal's user.

Usually when an Internet user accesses a financial institution's web page and his account in particular, the attention paid to all the web page's features is higher. However, poor features, need of services and lack of benefits discourage users from accessing the financial institutions' web pages. For example, a better management of funds transfers and rewards points, such as more options as to the timing of the effectiveness of the transactions and/or customized offers to redeem points may render access to financial accounts through the web more attractive. Users all around the world look for rapid, secure and accurate transfer of funds services such as person to person, person to institution, payments, as well as other monetary transactions.

The present invention involves steps to provide a web portal with financial services comprising an efficient management of account financial services, more options to redeem reward points and a secure and effective way to match users with advertisers wherein accurate information, such as financial information, is used as one of the criteria for matching the user with the displayed advertisement.

Furthermore, none of the existing art provides incentives to the user. The present invention provides several management options for the distribution and redemption of reward points instead of just matching the advertisement with the user. The present invention provides a mechanism that allows advertisers to extend special offers to those users that match certain criteria based on the financial information and web-browsing behavior. The combination of the financial institution's and web portal ad targeting capability with traditional targeting resulting in web portals having the capability to charge advertisers a higher rate for a higher level of targeted precision in their advertising.

### SUMMARY OF THE INVENTION

The present invention provides a mean for managing bank account services, ad delivery, and reward points comprising a web portal, a financial institution and means to manage securely and effectively bank account services, reward points and advertisements.

The means to manage securely and effectively bank account services, reward points and advertisement comprises means to control processes and evaluate several data including financial data while providing several interfaces for the interaction between the user and the financial services. An administrative tool is provided as the mean to control processes and to evaluate data which enables the financial institution to manage security, marketing and financial services. The present invention provides a Bank Manager Program (BM) as the administration tool. The BM maintains control over the interface managing several services such as, but not limit to, mechanisms to validate, exchange information and notify the users throughout the process.

Therefore, an object of the present invention is to provide means to process different criteria and/or information while maintaining control over interfaces used for the interaction between users and a financial institution's services.

Another object is to provide means to gather and store information at databases, such as but not limited to, financial and transactional information and user interaction with the web portal, wherein said information is used as criteria.

Another object is to provide means to control the advertisement display at a user's web page wherein an analysis and matching process between the user's preferences and the ads is performed based on accurate information, such as current financial information.

Another object of the present invention is to provide customized ads for users wherein special offers are presented to clients based on their preferences as determined by certain criteria.

Another object of the present invention is to provide means for the management of reward points wherein said means will permit the user to redeem points to pay financial institution fees and/or to pay for products offered pursuant to the aforementioned targeted advertisements.

The present invention also provides means for funds transfers, wherein the payer or payee selects from a variety of possible effective time frames, each of which will require the payment of a different fee for the given speed of each time frame.

Yet another object is to provide means to control the account funds and reward points through several account cards linked to the same main account.

### BRIEF DESCRIPTION OF THE DRAWINGS

The accompanying drawings which are incorporated herein constitute part of the specification and illustrate embodiments of the invention.

FIG. 1 shows a block diagram of the present invention wherein the web portal is outside the financial institution's premises.

FIG. 2 shows a block diagram of the present invention wherein the web portal is inside the financial institution's premises.

FIG. 3 illustrates graphical user interface of the sign up interface.

FIG. 4a illustrates graphical user interface of the user's account.

FIG. 4b illustrates graphical user interface of the Advertiser interface.

FIG. 5a shows loadable cards linked to a main account FIG. 5b illustrate a graphical user interface of loadable cards management interface

FIGS. 6a-6d illustrates a graphical user interface of transfer fund interface

FIG. 7 illustrates a graphical user interface of confirmation interface

### DESCRIPTION OF THE PREFERRED EMBODIMENT

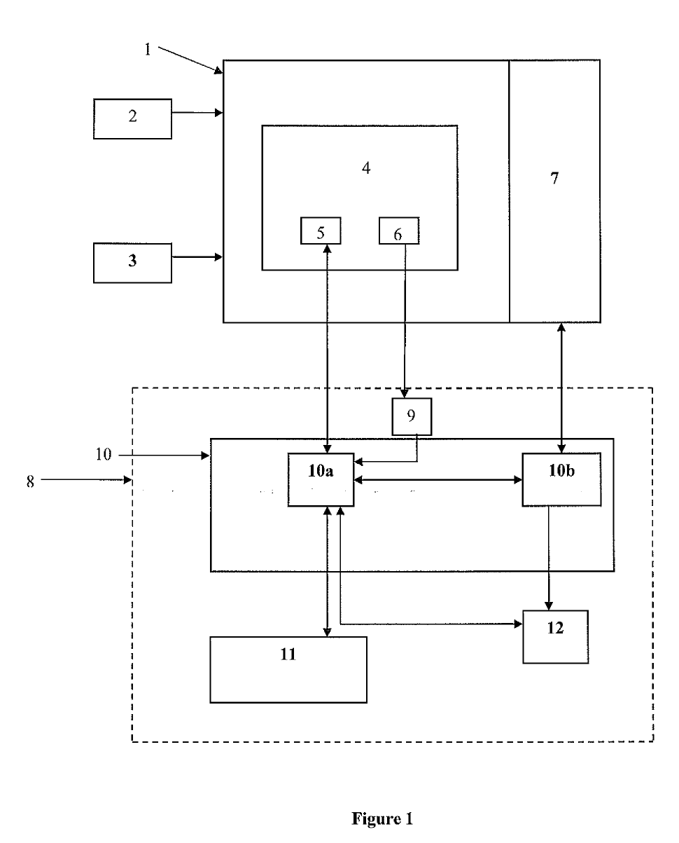

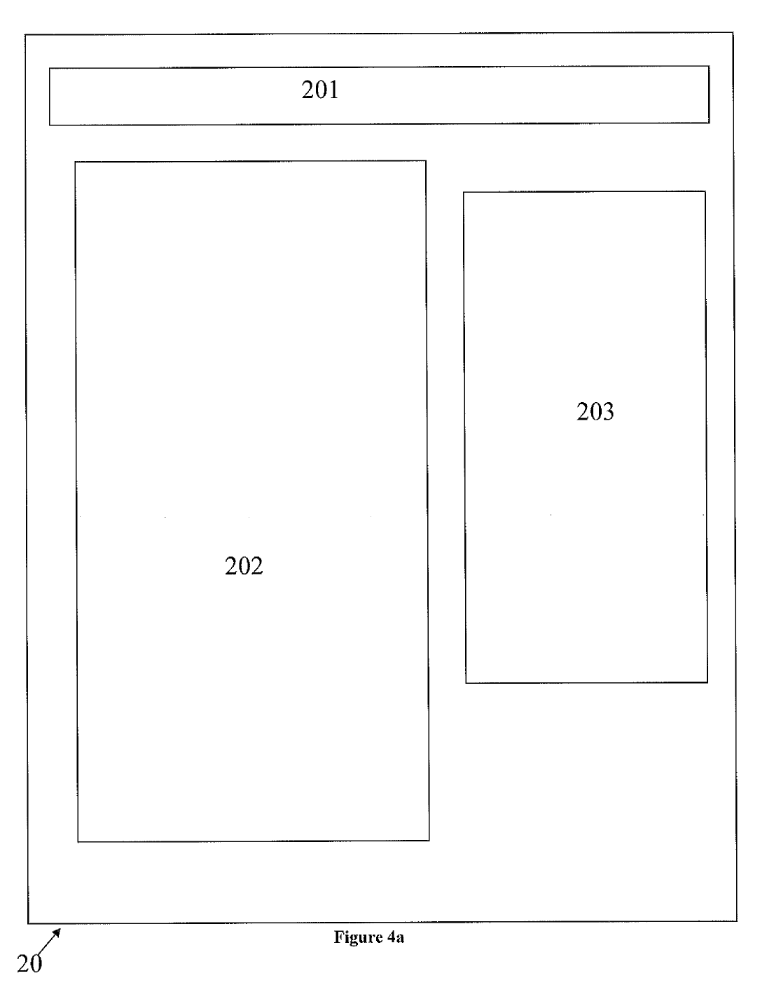

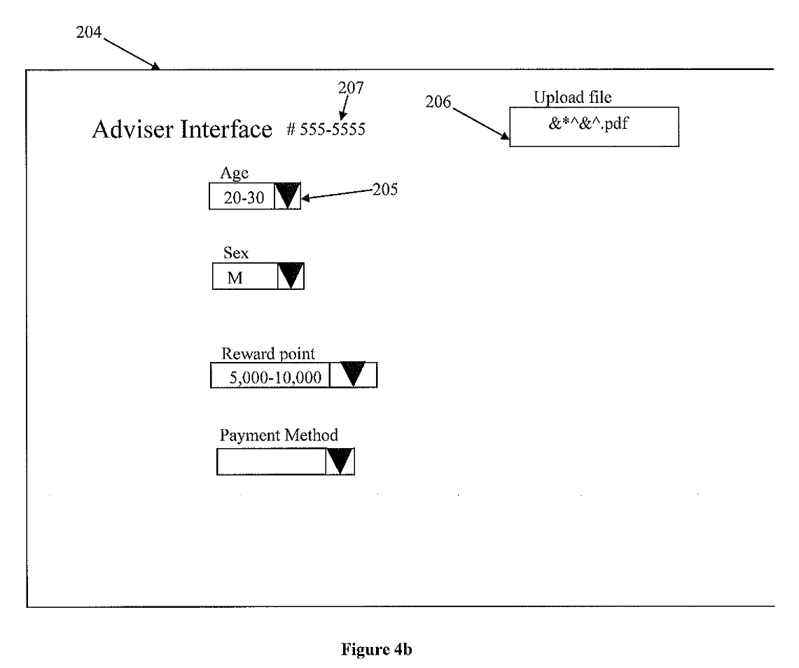

The present invention, as shown in FIGS. 1 through 7 provides means for managing bank account services, ad delivery and reward points comprising means to remotely access financial information from a financial institution having online financial services 2, 3, a service provider 1 wherein online financial services 4 are at least one of the services provided by the service provider, a financial institution 8 in control of the online financial services 4, means to allow users to interact with the financial institution 5, means for web browsing 6, means to process, control and manage information 10 between users and the financial institution 8, several interfaces 14, 20, 30, 40, 41, 42 wherein at least the user can acquire information regarding account status and customize, restrict or decide on user's exchangeable possession related to user's account, means to provide advertisement 7, 13, means to store information 9, 11, 12 and means to display advertisement 203 as an element or part of the user's account interfaces, as shown in FIG. 4.

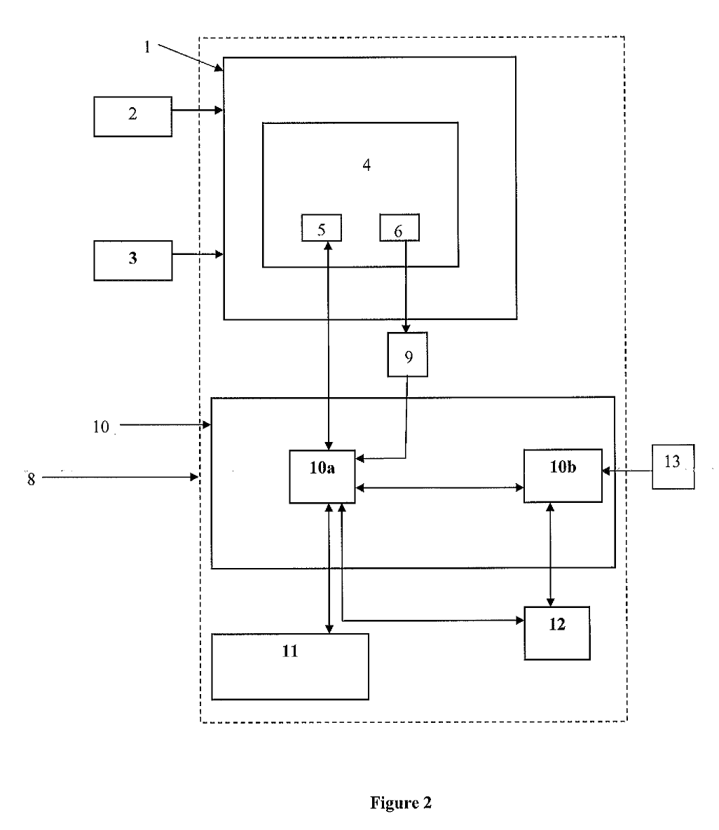

FIG. 1 and FIG. 2 disclose means to remotely access financial information from a financial institution having online financial services 2, 3 such as computers, mobile phones or any other device capable of exchanging information with a financial institution. The device is used by a customer of the financial institution, such as but not limited to, a company, person or institution which chooses the financial institution as their financial services provider. The customer or user is characterized for being a receiver and/or sender of funds using a computer or mobile phones 2, 3 to remotely access the financial information and services.

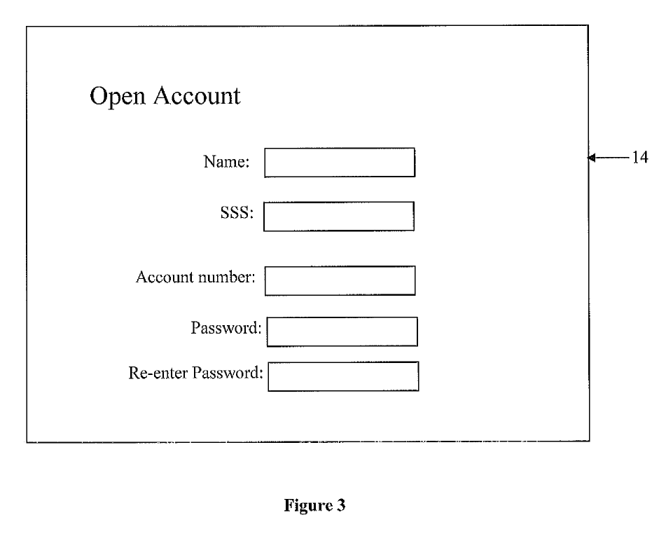

A web portal 1 or service provider provides online financial services 4 for customers or users wherein said services are controlled and managed by the financial institution 8. The online financial service can be a link to the financial institution at the web portal controlled by any third party, as in FIG. 1, or part of the financial institution 8, as in FIG. 2. Users 2, 3 generate or open their own individual account using means to allow users to interact with the financial account, more particularly with the given user's account. In the instant case a graphic user interface (GUI) 5 is used as the means to allow users interaction with the financial institution 8. During the sign-up process an interface 14 requests sensitive and pertinent information (such as account number, social security number and other security parameters) as illustrated in FIG. 3. The user might choose between signing-up and for accessing as a customer or an advertiser. Means to control process and manage information 10 between users and financial institution 8 store the information at a financial data base 12.

An administrative tool, such as a Bank manager Program 10 is used as the means to control processes and manage information. The Bank Manager Program or BM 10 is divided in two main parts—the Bank Information Manager (BIM) and the Bank Advertisement Manager (BAM), wherein the main purpose is to manage security, marketing and financial services. Basically the BM controls over the interfaces by managing several services such as the mechanisms to validate, store and exchange information. The BM also notifies the users throughout the process. As part of the control process and as mentioned above the BM interacts with the financial institution data base 11 in order to verify and store the user's information. The databases are located and operated within the financial institution's premises.

It is important to note that, as mentioned above, the web portal 1 may link to a financial institution in order to provide financial services 4, providing access to or working as a front end for the financial institution 8, wherein said web portal 1 is managed by an external financial institution or any third party as shown in FIG. 1. The foregoing embodiment works as a private label whereby the web portal's 1 brand is adopted to identify the financial services but the charter, back end and systems are those of the financial institution 8 offering the private label solution to the web portal. One of the advantages of signing-up from a web portal administrated by a third party is that the same user name or other identification and password used to access the financial institution online could also be used to access simultaneously the third party web portal 1 services (and vice-versa) such as but not limit to, email accounts, calendars, news and any other non-financial service generally provided by said web portal 1. Another embodiment is a web portal that is part of the financial institution 8 itself, providing the online financial services 4 as shown in FIG. 2.

Furthermore, after the sign-up process, if the users want to access their individual accounts through the web portal 1, they are required to provide certain access information such as a user name and/or a password and/or a digital certificate to maintain a secure connection with the financial institution through the communications system.

After access is granted to the user's account, another GUI is presented to the user. The new interface is the user's account interface 20 which comprises a space for displaying user's account information 202, ads 203 and the offering of several financial services 201, such as but not limited to, payments, funds transfers and others. While acquiring information regarding user's account the BM, more particularly the BIM, presents several ads 203 at the space provided on the web page or GUI 20. The BIM goes through a selection process for matching users' stored information with advertisers' ads. The selection process is based on the analysis of certain criteria such as stored information in the premises of the institution bank instead of being a random selection. The process is usually called criteria matching process. The criteria matching process requests criteria from the financial institution's data base 11 to start the evaluation and matching. For example, financial information used may be average account balance, home address, recent purchases, stores visited in the last thirty days, recent visits to a particular restaurant and others. The criteria parameter might vary depending on the financial institution. The BIM may use other information as part of the criteria matching process. For example, information such as the web browsing behavior obtained from the means for web browsing 6 is combined with financial information. The web browsing behavior is stored and acquired from the miscellaneous database 9 which is located within the financial institution's 8 premises.

Several ways to perform the analysis of the stored data in order to match a user with an ad can be implemented. In the instant case the Bank information manager (BIM) accesses the financial institution's database 11 and/or miscellaneous database 9 which securely holds private, sensitive and personal financial information of customers, such as personal identifying information, names, dates, financial and commercial transactions, contact information, age and gender, emails, account numbers, phone numbers, credit and debit card numbers, addresses, accessed news, searches and other similar information. Each customer in the financial database 11 and miscellaneous database 9 is identified through a customer identification number (CIN). No financial and/or customer information ever leaves the financial customer database, therefore no personal identifiable information is disclosed to unaffiliated third parties including the web portal and the advertiser.

Upon the completion of the criteria matching process, the selection is done and the placement of the advertisement for the user's account GUI 20 space starts. At this moment, the BIM 10a requests from the Bank Advertisement Manager (BAM) 10b the ads that match certain criteria.

As mentioned above, the BAM controls the acquisition and management of ads. During the acquisition of ads from an external advertisement data base 7, 13 the BAM stores the information in an internal or financial ad data base 12 before the acquired advertisement interacts with the BIM 10a. The BAM may acquire ads by different methods such as, but not limited to, from an ad network 7 or directly from the advertiser 13. The BAM 10b provides an advertiser interface 204 in order to acquire advertiser information, such as advertisement and desired customer target criteria preferences (for example, age, address, average balance, recent purchases) directly from the advertiser 13. The advertiser interface 204, as illustrated in FIG. 4b, comprises at least means to upload the ad 206, advertiser identification 207, criteria selection 205 and method of payment 208. The criteria selection helps advertiser 13 to choose his intended audience or to whomever the advertiser wants to see his ad on the web page. Different methods of payment, such as bids and others are provided by the advertiser interface 204.

The ads database 12 contains all the media content that may be transmitted to the user. The financial ad database 12 may be implemented and exist: (i) within the whole system of the financial institution (for example, the ad database and its content exists inside the same computer or inside or within the same cluster of computers as the financial customer database); (ii) separate from the financial database 11 but still within control or under the financial institution computer system or as an attachment to the financial institution computer system. Each piece of ad content in the ads database has an ad identification number (AIN). Part of the number that comprises a specific AIN may be code descriptive information of the ad (for example, AINs may be 32 bits long, and AINs starting with ‘000’ are pictures, AINs starting with ‘010’ are music, AINs starting with ‘100’ are not suitable for minors, etc.) The ads database creates an AIN list, where the list contains all AINs which point to the content of the ad database.

The BIM 10a associates a particular CIN with a particular ad or ads or a particular AIN or AINs. Depending on the embodiment, if the ad database is implemented to function through embodiments (i) or (ii) as described above, in the preferred embodiment the financial institution computer BIM picks the ads directly from the ad database 12 based on the AINs from the BAM 10a. The financial institution, through the BIM and using the financial institution's 8 data bases 9, 11, 12 delivers and/or places the ad to the GUI users' account 20. It is important to mention that even when the targeted ads are placed at the user's account interface 20, they might be displayed at any time on any interface provided by the web portal and is not limited to only be displayed when user is using the financial services. Therefore the BM always chooses the ad or ads to display to the customer, by means of the BIM and BAM. In this embodiment the financial institution does not send financial or personal information to any external ads database network 7 but instead it sends only an ad request using the AINs. The customer receives the ads chosen by the financial institution through the financial institution's implementation of a method of placing ads on a web portal.

The means for acquiring ads, as mentioned above, includes an interface for advertiser 13 (who may be a dealer, marketer, or vendor) to upload ads and placed them in the ads database 12. It also creates and/or defines a market segment that correlates to advertiser's intended audience or to whomever the advertiser wants to see his ad on the web page. A targeted market segment is a group of customers or entities that may be identified as a group through selecting one or more criteria based on the different types of information contained within the financial institution customer database. Such targeted market segment or the conditions to pick such market segment are provided to the financial institution through the communications system or through any other means. The financial institution may: (a) apply CINs of customers that fall within the targeted market segment to AINs that correspond to said market segment; (b) match the customers profiles inside the financial institution's customer database 12 that fall within the targeted market segment to corresponding AINs; (c) match the customers profiles inside the financial institution's customer database 12 that fall within the targeted market segment directly to ads that reside in the financial institution's computer system; and/or (d) use similar means as the ones previously described, or a combination of such means under the same implementation. Nevertheless, the advertiser and/or the third parties may know the possible variables and/or criteria used for the matching of financial institution database 12, such as account balance, address, preferences in food, cars or clothing. However, this information is not of any particular financial customer but more a general criteria use to facilitate matching of the advertiser's ad with one or more users that meet the selected criteria. For example, an advertiser assigns to a targeted market segment specific ads which are in the ads database. After placing criteria for a market segment, the advertiser may receive general information of the pool of customers, such as the amount of people that match with the market segment, the average time it will take for a certain number of customers to view the ads and similar types of metrics, but all without disclosing to said advertiser and unaffiliated third party (UTP) non-public personal identifiable information (NPPII) of financial institution clients. Such conduct of the disclosing of NPII to an UTP could violate federal and state banking laws and regulations. Further, since advertisers know certain targeted market segment criteria, they might provide special offers as incentives or the possibility to redeem reward points for the advertiser's product or services. The use of incentives and reward points make the advertiser's product more desirable thus potentially increasing the probability of the user clicking at the ad or purchasing the offered product. The offers can be limited by time, a maximum number of offers, or any other limitation.

As mentioned above, the advertiser 13, or a third party on behalf of the advertiser, may create and upload content (such as pictures, music, sound recordings, video, or any other media) to be used as an ad (or a component of an ad) to be placed in the ad database and be assigned an AIN. The BAM decides whether which ad or content is allowed to enter the ad database 12 serving as an ad filter, where the ad or content to be checked waits for various checks, such as virus detection, quality control (such as size and format), spyware and malware detection, subjective content check (for example, to check that a competitor of the financial institution does not advertise through the system or unwanted pornography), or any other types of checks. These checks may be completed several times before reaching the ad data base 12 at any point, but in any case the BAM is able to prevent corrupt, improper, or virus infested ads or content to enter the systems described herein.

The invention also comprises several enhanced financial services 201 provided at the GUI user account. Some of the services are PFM (personal financial management), transfer of funds including p2p (person to person) payments, p2c (person to commerce) payments and customizable email alerts.

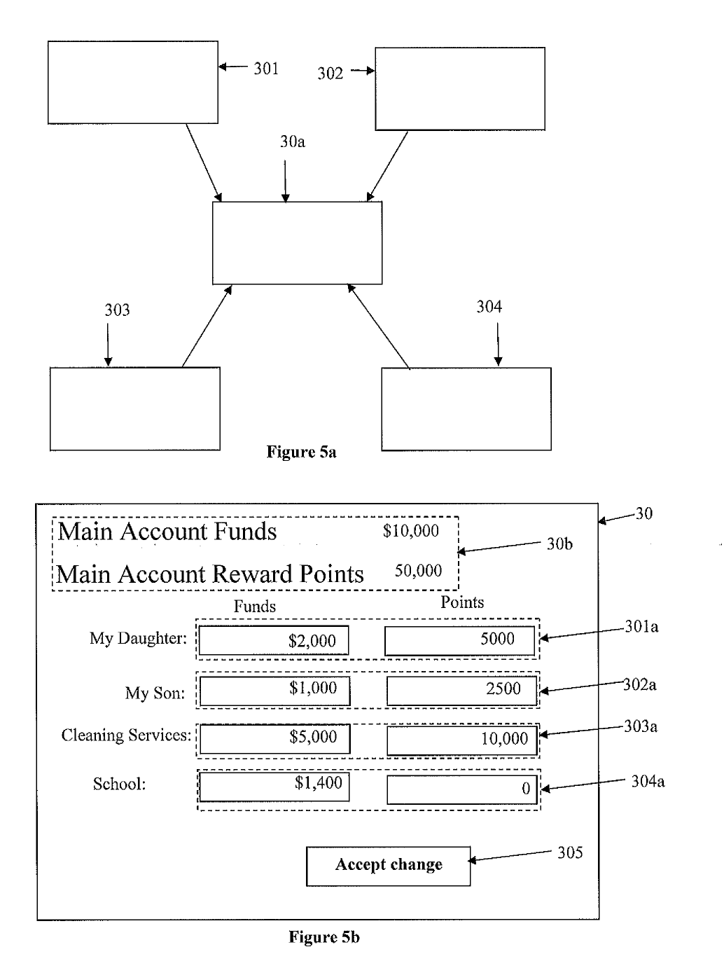

The personal financial management, as shown in FIG. 5a, includes linking several account cards 301-304 to a main account 30a. The present invention provides for the use of several cards wherein each card comprises an identification number or sub-account in order to distinguish one from the other. The transactions with each particular card are stored as separate cards but related to the main account. Each card has its purpose and might correspond to a different product inside the financial institution. As shown in FIG. 5b, a GUI for the loadable card management 30 is provided. The account's user can transfer in real-time any user's exchangeable possession related to the user's account such as funds and reward points from one account to another. The GUI for loadable card management 30 at least shows the main account funds and reward points 30b and several input boxes 301a-304a related to each particular card. The user controls the distribution of the funds associated with each card without exceeding the main account's limits. Also the user controls the rewards points by assigning points to each account. Point management provides the user the option to link cards to use points and redeem reward points for prices based on the preferences of each card user. For example, if a card 303, is designated for the user's cleaning services employee and the user is presented with an ad for house cleaning equipment that may be acquired through the redemption of points the user can assign points to the cleaning services employee's card user in order to redeem points for the house cleaning equipment. Redeemable gifts may also or, if desired, only be obtained at a physical store. After an assignment of points is made as to one or more debt cards, the user accepts 305 such assignment and the BIM transfers the corresponding funds and reward points. When the transaction is completed, the BIM creates an alert and sends it to the user. Using the loadable card management GUI 30, users will be able to transfer funds or reward points to each loadable card directly from the main banking account in real time to complete online and/or offline payments and/or purchases.

The personal financial management also provides means for funds transfer wherein the user (payer or payee) can select from a variety of possible time frames for the effectiveness of each corresponding transaction fee. For example, the user can pay a 25 dollar fee for a same day time frame fund transaction or a 15 dollar fee for a 3 days time frame fund transaction. Another fee payment option can be a percent of the amount to be transferred. For example, the user pays a 10% fee of the amount to transfer for a same day time frame fund transaction or a 5% fee for a 3 days time frame transaction. Also unlike conventional transaction fees the system can allow for either payer or payee to satisfy the flat fees for a given transfer transaction.

Before any funds transfer is performed the account user has to provide information regarding destination account(s) in order to link the user's account to any account inside or outside the financial institution. For those accounts outside the financial institution a more rigorous process is undertaken for security purposes and higher fees for transactions may be set. After the accounts are linked, the user is able to transfer funds from the user's current account to any other account inside or outside the financial institution. An interface for the user fund transfer process is provided as part of the bank services. The funds transfer interface requires information from the user such as amount to be transferred, account number and when will the transferred funds be made available.

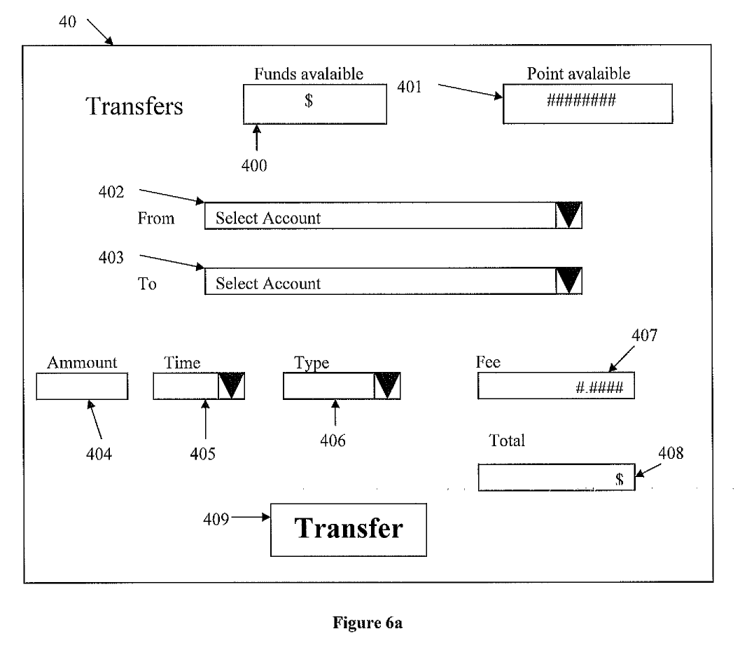

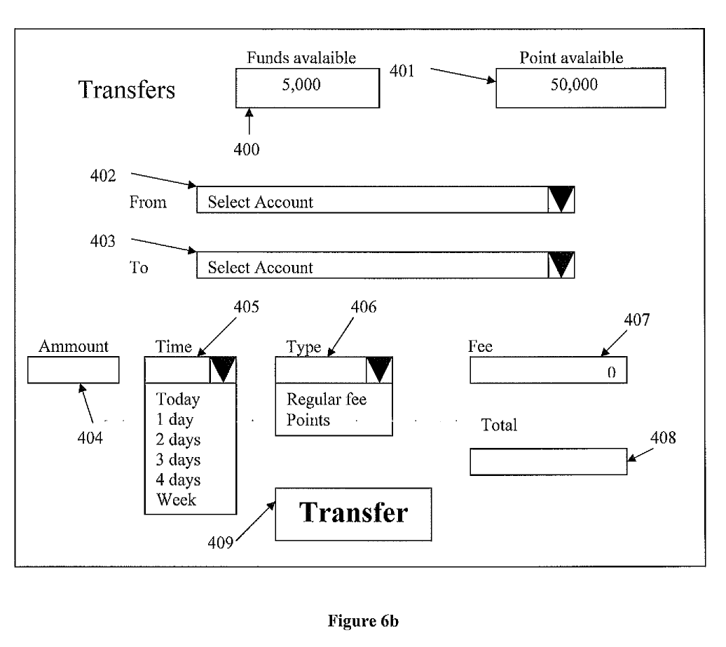

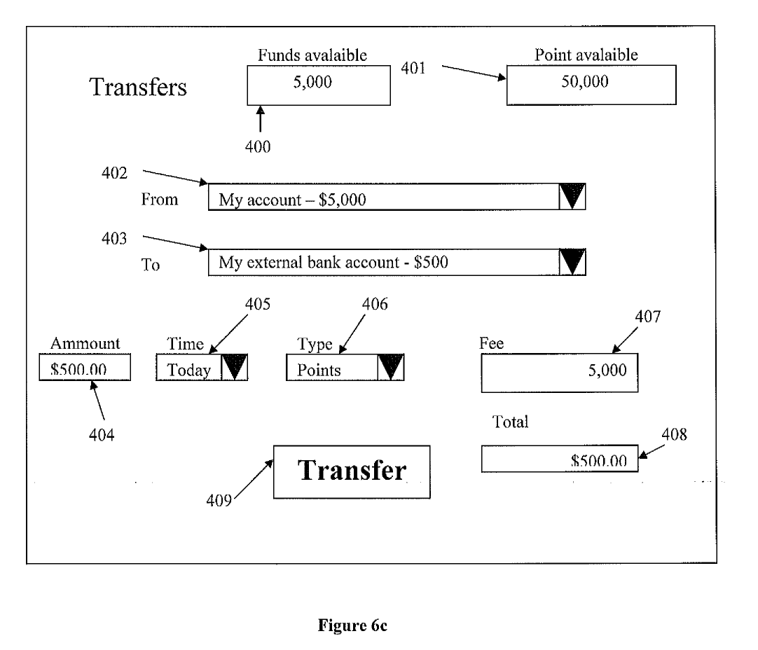

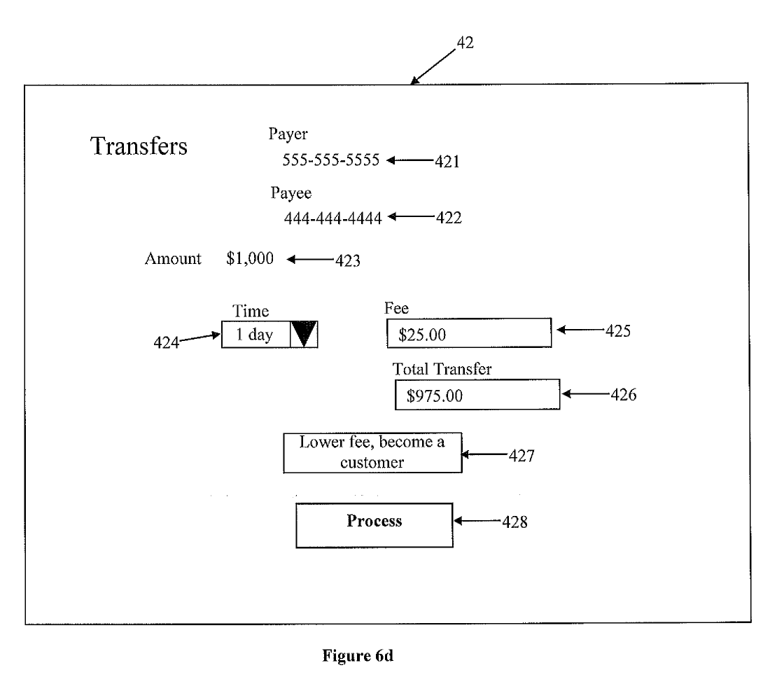

FIGS. 6a-6c show the means to transfer funds inside the bank, wherein a GUI for funds transfer 40 is provided in order to transfer funds between accounts linked to the user's account. As mentioned above, the internal and external accounts linked to the user's account are provided by the user and approved by the financial institution following the security process. The GUI for fund transfer 40 comprises displays such as funds available box 400, reward points box 401, account selection boxes 402, 403, amount to transfer input box 404, timing for the effectiveness of the transfer selection box 405, type of fee payment box 406, fee display box 407 and a total deduct amount display box 408. Furthermore, the funds transfer service is also combined with the rewards program in such a way that the user may choose to redeem reward points for the transaction service instead of deducting money from the user's account.

During the funds transfer process the GUI for funds transfer 40 displays the amount of funds available 400 to use and the total amount of rewards points 401. The information displayed at the funds available box and total amount of reward points is related to the account from where the funds are deducted. The selection of the account is performed at the account box selection 402, wherein a menu of available accounts is provided for selection by the user. As soon as the account selection is made through the appropriate boxes 402, the funds available and reward points for the selected account are modified in real time status to reflect the corresponding deduction. Furthermore, the user selects the account 403 to where the funds are to be transferred. Each account has its own restriction; therefore, the timing of the transfer and amount of funds transferred will vary depending on the selection. However, the BIM 10a behind the transfer interface 40 controls the option presented to the user, wherein said option is limited to the account selections.

Following the selection of the account, the user enters the funds at the amount input box 403 to transfer an amount of funds not to exceed the amount of funds available 400. Next, the users select the timing of the effectiveness of the transfer which is conditioned by the account selection 403. The timing 405 provided by the interface ranges from real-time transactions to several days, however some specific options may be calculated by the BIM 10a and displayed by the transfer interface 40. Depending on the timing selection, a transaction fee is generated and displayed at the fee box 407. The present invention also offers, as part of the user's selection, the opportunity to redeem points for the transaction service, therefore providing the option to pay for the total cost of the transfer using reward points, thus selecting “no charge” as the fee option.

If the user selects a regular fee the BIM calculates a flat fee or a percent of the amount to transfer based on several criteria such as the account selection, time and amount of funds to transfer. On the other hand, if the user opts to redeem points, the amount of points needed for the transaction are generated based on several criteria such as the account selection, timing and amount of funds to transfer. The total amount to be deducted from the account is presented at the fee display box 407, wherein said amount is a result of the user's selections. The funds transfer options include, but are not limited to, payments, p2p transactions, p2c transaction and other fund transfer transactions.

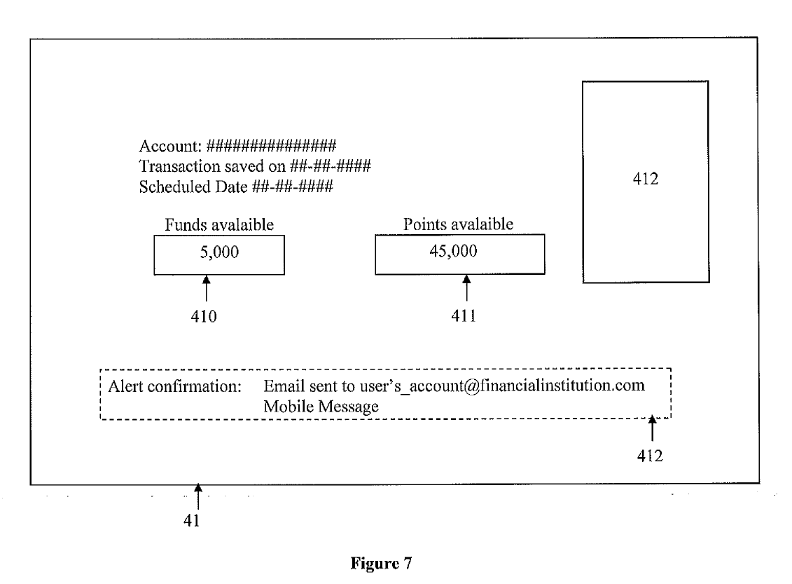

The next step for the execution of the service is to indicate to the BIM 10a to process the transaction. Usually this is performed when the user selects said instruction at the interface 40. The present invention contains a button 409 to start the execution of the service. The BIM 10a evaluates the information and verifies if the user can make the transaction. As mentioned above, any time the information is changed or a transaction is completed a notification is generated and sent to the user. Several types of notifications are included, such as electronic messages, letters, calls and others. Simultaneously, an interface 41 provides confirmation information of the transaction combined with the amount of funds transferred 410 and points available 411 on the selected account and an ad 412 as shown in FIG. 7. The notification displays an ad which is also selected by the BIM by the criteria matching process.

For external funds transactions, such as vendor payments, the financial institution generates and sends an alert to the payee. The payee can link to the financial institution through that alert in order to edit when to receive the payment. When payee accesses the link, the financial institution presents, as shown in FIG. 6d, an interface 42 controlled by the BM comprising a payee identification number 421, a payer identification number 422, an amount 423, timing of the transfer/payment selection 424, fee 425, amount to transfer 426, link to become customer 427 and means to allow transfer 428. Similar to the inner fund transaction the BM calculates the fee. A link to become a customer of the financial institution is provided in order to reduce the fee. When the payee allows the transfer an alert is generated.

While the invention has been described as having a preferred design, it is understood that many changes, modifications, variations and other uses and applications of the invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. The claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth herein in entirety. All, or substantially all of, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentably distinguish any amended claims from any applied prior art.

I claim:

1. A system to securely and effectively manage bank account services, reward points and advertisements, comprising:
(i) a service provider having a means for web browsing, wherein said service provider offers at least online financial services;
(ii) a financial institution, wherein said financial institution is in control of the online financial services and wherein said service provider works as a front end of the financial institution;
(iii) means to remotely access financial information from the financial institution comprising means to securely handle said financial information, wherein said means to remotely access financial information are also used to access the online financial services;
(iv) means to store user specific information and criteria, said user specific information comprising financial information, ads from external sources or advertisers and at least part of any information browsed through the service provider's means for web browsing;
(v) means to allow the users of the system to interact with the online financial services comprising a means to control the transaction time of a financial activity and at least one interface providing means to display advertisements, a plurality of financial services and said financial information, wherein said means to allow the users of the system to interact with the online financial services further comprises at least one interface to link a plurality of accounts to a main account and at least one interface to manage and control an account exchangeable possession, wherein said account exchangeable possession comprises funds and reward points; and
(vi) means to process, control and manage said financial information between users, the system, and the financial institution, wherein said means to process, control and manage said financial information analyzes the financial information and based on the criteria stored in said means to store user specific information and criteria, matches ads with the analyzed information, acquires ads from said means to store user specific information, places matched ads at any of the plurality of the interfaces provided by the service provider, wherein said means to process, control and manage information between users and the financial institution controls, processes and manages said means to allow users to interact with the online financial services, wherein said means to process, control and manage information between users and the financial institution generates an alert after a financial service is completed, wherein said alert at least comprises an ad selected from the analysis of the user specific information and criteria.

2. A system to securely and effectively manage bank account services, reward points and advertisements, comprising:
(i) a service provider, wherein said service provider offers at least online financial services;
(ii) a financial institution, wherein said financial institution is in control of the online financial services;
(iii) means to remotely access financial information from the financial institution;
(iv) means to process, control and manage information between users the system and the financial institution;
(v) means to allow the users of the system to interact with the online financial services; and
(vi) means to store information, wherein said stored information at least includes financial information and advertiser information.

3. A system to manage securely and effectively bank account services, reward points and advertisements as in claim 2, wherein the service provider works as a front end for the financial institution.

4. A system to manage securely and effectively bank account services, reward points and advertisements as in claim 2, wherein the service provider is administrated by a third party as the front end for the financial institution, wherein the means to access the financial institution services are also used to access the service provider services.

5. A system to manage securely and effectively bank account services, reward points and advertisements as in claim 4, wherein the means to access the online services comprises a means for handling sensitive information.

6. A system to manage securely and effectively bank account services, reward points and advertisement as in claim 2, wherein said information at least includes financial information and advertiser information.

7. A system to manage securely and effectively bank account services, reward points and advertisement as in claim 2, wherein said means to process, control and manage information between users and financial institution acquires ads from an external source and store ads at the means to store information.

8. A system to manage securely and effectively bank account services, reward points and advertisement as in claim 2, wherein said means to process, control and manage information between users and financial institution analyze user information stored at the means for storage information, wherein said user information at least include financial information.

9. A system to manage securely and effectively bank account services, reward points and advertisement as in claim 8, wherein said means to process, control and manage information between users and financial institution matches ads with the analyzed information base on certain criteria.

10. A system to manage securely and effectively bank account services, reward points and advertisement as in claim 9, wherein said means to process, control and manage information between users and financial institution places matched ads at any interface provided by the service provider.

11. A system to manage securely and effectively bank account services, reward points and advertisement as in claim 2, wherein said means to process, control and manage information between users and financial institution control, process and manage said means to allow users to interact with the financial service.

12. A system to manage securely and effectively bank account services, reward points and advertisement as in claim 11, wherein said means to allow users to interact with the financial service comprises at least one interface providing means to display advertisement, several financial services and user financial information.

13. A system to manage securely and effectively bank account services, reward points and advertisement as in claim 11, wherein said means to allow users to interact with the financial service comprises at least a interface to process, manage and control advertiser information.

14. A system to manage securely and effectively bank account services, reward points and advertisement as in claim 11, wherein said means to allow users to interact with the financial service comprises at least one interface to link several account to a main account.

15. A system to manage securely and effectively bank account services, reward points and advertisement as in claim 11, wherein said means to allow users to interact with the financial service comprises at least one interface to manage and control an account exchangeable possession.

16. A system to manage securely and effectively bank account services, reward points and advertisement as in claim 15, wherein said account exchangeable possession comprises funds and reward points.

17. A system to manage securely and effectively bank account services, reward points and advertisement as in claim 11, wherein said means to allow users to interact with the financial service comprises at least mean to control the transaction time of a financial activity.

18. A system to manage securely and effectively bank account services, reward points and advertisement as in claim 2, wherein said means to process, control and manage information between users and financial institution generate an alert for user after a financial service is completed, wherein said alert at least comprises an ad selected from the analysis of certain criteria.

19. A system to manage securely and effectively bank account services, reward points and advertisement as in claim 2, wherein said service provider comprises means for web browsing, wherein a part of the web browsed information is stored at the means to store information.
